(19) United States
(12) Patent Application Publication
(10) Pub. No.: US 2017/0221150 A1
(43) Pub. Date: Aug. 3, 2017

(54) BEHAVIOR DEPENDENT INSURANCE

(71) Applicants: Matan BICHACHO, Tel-Aviv (IL); Grace HARARI, Tel-Aviv (IL)

(72) Inventor: Matan BICHACHO, Tel-Aviv (IL)

(21) Appl. No.: 15/323,995

(22) PCT Filed: Jul. 7, 2015
(86) PCT No.: PCT/IL2015/050699

§ 371 Date: Jan. 5, 2017

Related U.S. Application Data
(60) Provisional application No. 62/021,775, filed on Jul. 8, 2014.

(51) Int. Cl. G06Q 40/08; G06Q 30/02

(52) U.S. Cl. CPC G06Q 40/08; G06Q 30/0284; G06Q 50/30

(57) ABSTRACT

A method for personalizing a per ride insurance rate which comprises receiving a current insurance rate per distance unit calculated based on a user profile of at least one of the driver and the vehicle, identifying an initiation of the ride with the vehicle by the driver, calculating driving behavior parameters reflecting driver behavior during the ride according to outputs of at least one driving parameter sensor mounted in the vehicle during the ride, identifying a termination of the ride, calculating an insurance cost for the ride according to a distance accumulated during the ride and the current insurance rate per distance unit, calculating an update to the current insurance rate per distance unit according to the driving behavior parameters, and presenting the update and the insurance cost on a display of the client terminal to the driver in the vehicle in response to the detection of the termination.

### BACKGROUND

The present invention, in some embodiments thereof, relates to insurance and, more specifically, but not exclusively, to dynamic insurance management.

Conventional methods for determining costs of insurance involve classification of driver, vehicle, type of cargo and type of operation into broad actuarial classes for which the expected insurance cost can be predicted with reasonable accuracy based on the empirical experience of the insurer. The basic costs determined by the actuarial classification can be further adjusted by discounts and surcharges. The discounts and surcharges are a form of refinement of the classification. The choice of characteristics which will be used to determine the basic cost and which to determine the surcharges and discounts is subjective and to a degree arbitrary.

The more recently suggested methods address the mentioned weaknesses of the conventional automobile insurance pricing by collecting data on vehicle movement from on-board Global Positioning Systems or other on-board devices. The collected information is processed and subsequently communicated to the insurer who periodically adjusts the insurance cost based on the communicated information.

### SUMMARY

According to some embodiments of the present invention, there is provided a method for personalizing a per ride insurance rate, comprising: performing the following by a module executed by a processor of a client terminal located in a vehicle driven by a driver: receiving a current insurance rate per distance unit calculated based on a user profile of at least one of the driver and the vehicle, identifying an initiation of the ride with the vehicle by the driver, calculating a plurality of driving behavior parameters reflecting driver behavior during the ride according to outputs of at least one driving parameter sensor mounted in the vehicle during the ride, identifying a termination of the ride, calculating an insurance cost for the ride according to a distance accumulated during the ride and the current insurance rate per distance unit, calculating an update to the current insurance rate per distance unit according to the plurality of driving behavior parameters, and presenting the update and the insurance cost on a display of the client terminal to the driver in the vehicle in response to the detection of the termination.

Optionally, the plurality of driving behavior parameters comprises a speed compliance calculated based on an analysis of velocity data gathered during the ride.

Optionally, the at least one driving parameter sensor comprises a plurality of driving parameter sensors; wherein the plurality of driving behavior parameters comprises a adaptation of the driving to road conditions calculated based on an analysis of a correlation between of outputs of the plurality of driving parameter sensors.

Optionally, the plurality of driving behavior parameters comprises a reaction time calculated based on an analysis of image data gathered during the ride from the at least one driving parameter sensor.

Optionally, the at least one driving parameter sensor comprises a passenger compartment camera which images at least part of the passenger compartment space; wherein the plurality of driving behavior parameters comprises at least one of a mirrors check frequency, shifting a road gaze frequency, and a blind spot check frequency calculated based on an analysis of image data during the ride from the passenger compartment camera.

Optionally, the plurality of driving behavior parameters comprises at least one recorded driving behavior report documenting a vehicle driving violation during the ride, the at least one recorded driving behavior report being uploaded by at least one of a another driver and a law enforcement system.

Optionally, the at least one driving parameter sensor comprises a front camera which images the space in front and/or back of the vehicle; wherein the at least one driving parameter sensor comprises a stopping room average calculated based on an analysis of image data during the ride from the front camera.

Optionally, the at least one driving parameter sensor comprises a front camera which images the space in front of the vehicle; wherein the at least one driving parameter sensor comprises at least one of a lane compliance and a sign compliance calculated based on an analysis of image data during the ride from the front camera.

Optionally, the at least one driving parameter sensor is selected from a group consisting of an accelerometer, an image sensor, a magnetometer, a navigation system, an external insurance policy enforcement device, and a safety belt compliance sensor.

Optionally, the client terminal is a Smartphone set to be mounted in the vehicle during the ride.

Optionally, the client terminal is a subsystem of the vehicle.

Optionally, the current insurance rate per distance unit is received over a network from a central unit; further comprising sending the update to the central unit for updating the current insurance rate per distance unit.

Optionally, identifying the initiation and identifying the termination is performed by detecting a presence or an absence of wireless signal from an accessory of the client terminal.

Optionally, identifying the initiation and identifying the termination is performed by detecting a pairing between an accessory of the client terminal and the client terminal.

Optionally, the method further comprises calculating a ride cost for the ride based on a combination of the insurance cost and at least one of gasoline consuming data and value lost for the vehicle estimation; wherein the presenting comprises presenting the ride cost.

Optionally, the calculating an update is performed based on road condition parameters which are associated with the condition of at least one road driven during the ride.

Optionally, the calculating an update is performed based on environmental parameters reflecting environment condition during the ride at least one road driven during the ride.

Optionally, the method further comprises generating a report which details the insurance with a plurality of characterizing features of the ride as a row in a table.

According to some embodiments of the present invention, there is provided a method for presenting insurance data. The method comprises performing the following by a module executed by a processor of a client terminal located in a vehicle driven by a driver: identifying an initiation of a ride with a vehicle driven a driver, gathering a plurality of driving parameter sensor parameters from at least one driving parameter sensor mounted in the vehicle during the ride, calculating a plurality of driving behavior parameters reflecting a driver behavior during the ride according to an analysis of the plurality of driving parameter sensor parameters, identifying a termination of the ride, automatically calculating an update to an insurance rate set for at least one of the driver and the vehicle based on the plurality of driving behavior parameters, and presenting the update to the driver in a display in the vehicle in response to the detection of the termination.

According to some embodiments of the present invention, there is provided a system for personalizing a per ride insurance rate. The system comprises a database which hosts a plurality of user records, each one of the plurality of user records documents a current insurance rate per distance unit calculated for at least one of a driver and a vehicle, a client module executed on a client terminal for identifying an initiation and a termination of a ride with the vehicle by the driver and for gathering outputs of at least one driving parameter sensor mounted in the vehicle during the ride, a rate calculation module configured to calculate a plurality of driving behavior parameters reflecting driver behavior during the ride according to the outputs and configured to calculate an insurance cost for the ride according to a distance accumulated during the ride and the current insurance rate per distance unit. The rate calculation module is configured to calculate an update to the current insurance rate per distance unit according to the plurality of driving behavior parameters. The client module is configured to instruct a display of the client terminal to present the update and the insurance cost to the driver in the vehicle in response to the detection of the termination.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a method of generating and presenting a real time indication for updates and/or changes in a dynamic insurance policy of a driver when a termination of a ride to which the insurance policy has been applied to is detected, according to some embodiments of the present invention;

FIG. 2 is a schematic illustration of a system which manages a plurality of dynamic insurance policies for supporting real time updates of periodical insurances or ride insurances, according to some embodiments of the present invention;

FIGS. 3A and 3B are screenshots of a display of a current insurance rate before a ride is detected, according to some embodiments of the present invention;

FIG. 4 is a flowchart of a method personalizing a rate per distance unit insurance based on driving behavior parameters of a driver during a ride and presenting the insurance personalization outcome to the driver immediately when the ride is over, according to some embodiments of the present invention;

FIGS. 5A and 5B are screenshots of exemplary presentations of the insurance cost for the ride, according to some embodiments of the present invention;

FIG. 6 is a screenshot of an exemplary report that details insurance cost per ride, according to some embodiments of the present invention; and

FIGS. 7A-7D which are screenshots of a GUI, according to some embodiments of the present invention.

### DETAILED DESCRIPTION

The present invention, in some embodiments thereof, relates to insurance and, more specifically, but not exclusively, to dynamic insurance management.

According to some embodiments of the present invention, there are provided methods and system for calculating the financial effect of the driving behavior of a driver during a ride on his insurance policy and presenting the financial effect to the driver immediately when the ride is over. The insurance policy may be a vehicle insurance policy, a life insurance policy, a third party insurance policy, and/or any combination thereof.

Optionally, a client module installed a client terminal may be used for gathering outputs of sensors which are located in the vehicle, such as accelerometers, image sensors and to analyze them in order to calculate driving behavior parameters which are indicative of driving ability (i.e. skills), driving habits, and driving routine as well as the risk the driver poses to himself and others. The driving behavior parameters are used for updating the insurance cost of driver or the vehicle for the updating rides, for example a per distance unit rate or a per ride unit rate.

According to some embodiments of the present invention, the insurance policy update is supported by a central unit that gathers data on a plurality of users and insurance policies.

The methods and systems provide a mechanism that encourages the driver to improve driving behavior parameters such as sign and lane compliance, stopping room average, adaptation to road conditions and/or the like by providing him with an immediate feedback to his driving behavior without destructing him during driving.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

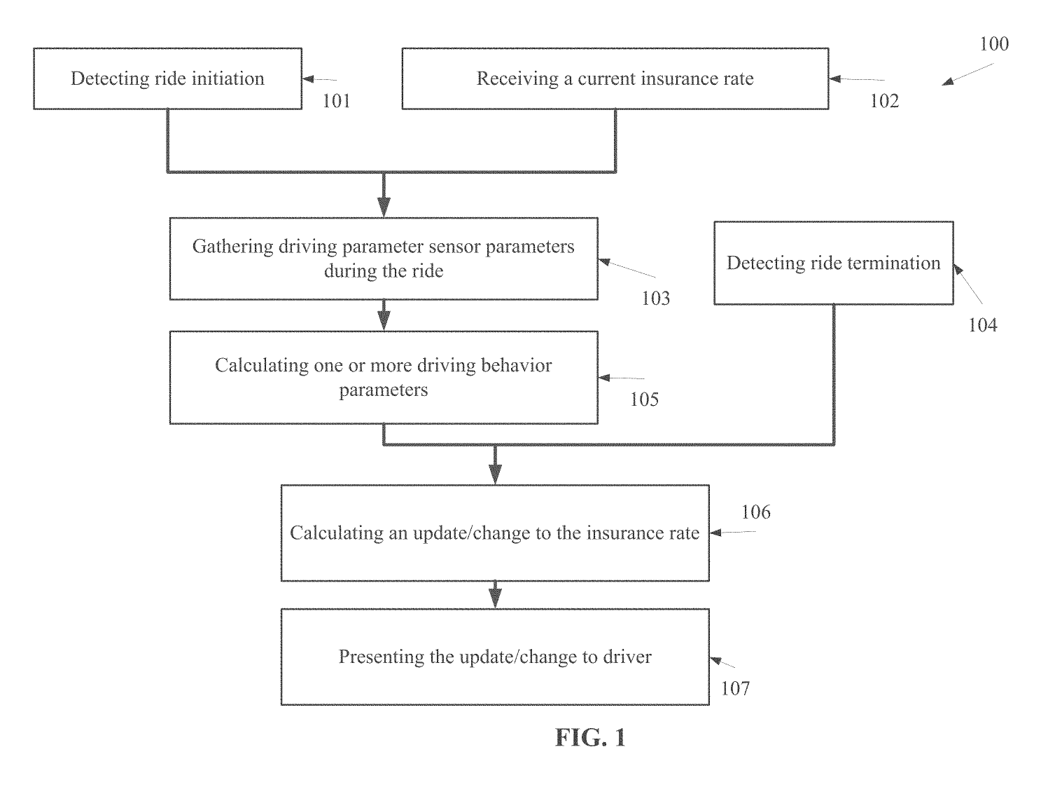

Reference is now made to FIG. 1, which is a method 100 of generating and presenting a real time indication for updates and/or changes in a dynamic insurance policy of a driver or a vehicle when a termination of a ride to which the insurance policy has been applied to is detected, according to some embodiments of the present invention. As used herein, a ride means traveling with a vehicle from one location to another when the driver does not go out of the vehicle during the traveling. The insurance policy may be a vehicle insurance policy, a life insurance policy, a third party insurance policy, and/or any combination thereof.

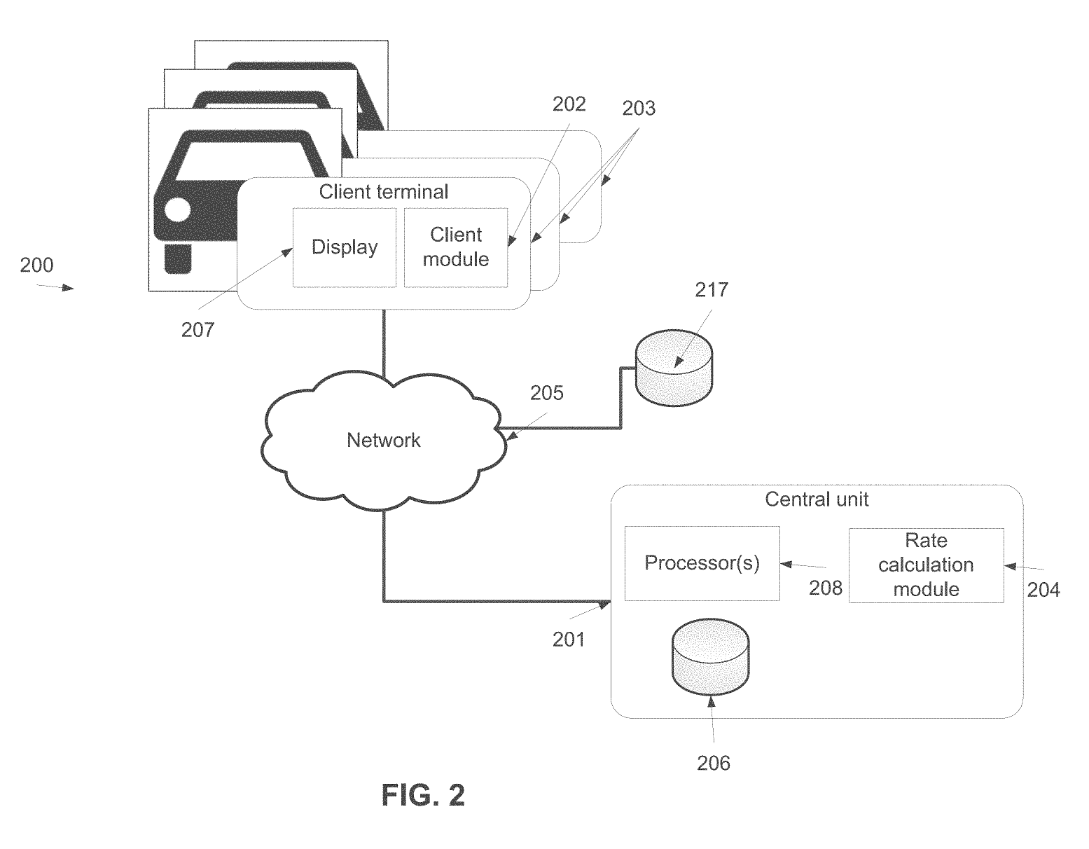

Reference is also made to FIG. 2, which is a schematic illustration of a system 200 which manages a plurality of dynamic insurance policies for supporting real time updates of periodical insurances or ride insurances, such as per-ride insurances, based on at least driver behavior and the presentation of the real time updates to drivers, according to some embodiments of the present invention.

The system 200 includes a central unit 201 for conducting insurance policy updates based on data received from a plurality of client modules 202 which are installed in a plurality of client terminals 203. The central unit 201 may be implemented using one or more servers and/or one or more virtual machines and connected to a network 205 such as the internet. A client terminal 203 may be a Smartphone, a tablet, an infotainment system, a computer based wearable device, a laptop and/or any computer based device connected to the central unit 201 via a communication network 205, such as the internet. A client module 202 may be an application such as an app store, an operating system application, and/or a preinstalled application.

In some embodiments, the client terminal 203 is part of the infotainment system of a vehicle or any other processor based subsystem integrated physically and/or electronically with the vehicle subsystems. The client terminal 203 includes or connected to a display 207, such as a dashboard display unit or windshield display unit which presents insurance policy data and updates, for instance as calculated above. In some embodiments, the client terminal 203 is a handheld device, such as a Smartphone, which is set to be mounted on a mount physically connected to the vehicle. In such embodiment, some or all of the driving parameter sensors which are described below are integrated into the client terminal 203.

Optionally, the client terminal 203 includes or connected to one or more driving parameter sensors, such as accelerometers, image sensors, magnetometers, a navigation system, such as a global positioning system (GPS), safety belt compliance sensor, and/or the like (not shown). The driving parameter sensors are controlled to record ride data that is later processed, either locally or by a respective client module 202 or remotely at an analysis module executed by the central unit 201. The processing of the outputs of the driving parameter sensors allows calculating and scoring driving behavior parameters and/or a combination of driving behavior parameters which are relate to a certain driver. A driving behavior parameter may be a driving event indicative of driving behavior pattern, for example any of the driving behavior parameters described herein forth. The driving behavior parameters may be any of the following:
Adaptation of the driving to the road conditions, such as bumpiness, traffic, visibility and/or the like. Such adaptation is calculated according to a correlation between of outputs of the plurality of driving parameter sensors, for example a correlation between image data reflecting the road and velocity or torque measured during the ride. For example, the road conditions may be determined based on image processing of a front camera that images the road in combination with other driving parameters, such as velocity or torques as acquired from navigation service or unit and one or more accelerometers, optionally in combination with time of the day, map data, and the like. Accelerometer data may be used for determining road conditions and matched with velocity data. Weather data, navigation data and/or map data may be used for extracting relevant road conditions, such as traffic and visibility. Statistical data regarding accidents in certain roads may also be used.
Reaction time, for example based on image processing of a front camera that images the cars in front of the driven vehicle in combination with other driving parameters, such as speed.
Safety belt compliance, for example based on image analysis of a passenger compartment camera or integral car sensors.
Mirrors Check frequency, for example from an analysis of image data gathered from a passenger compartment camera located to image the passenger compartment, either as part of the client terminal or physically separated therefrom.
Blind spot check frequency, for example from an analysis of image data gathered from a passenger compartment camera located to image the passenger compartment, either as part of the client terminal or physically separated therefrom.
Road gaze check, for instance the amount of time the driver does not look at the road while driving in relation to the driving period (e.g. after reducing stopping periods, such as traffic light periods), for example from an analysis of image data gathered from a passenger compartment camera located to image the passenger compartment, either as part of the client terminal or physically separated therefrom. The road gaze check may be averaged based on the driving period and/or correlated with road and/or velocity parameters.
Awareness and/or tiredness check, example based on image analysis of pupil focus extracted from image data gathered from a passenger compartment camera located to image the passenger compartment. The awareness and/or tiredness check may be averaged based on the driving period and/or correlated with road and/or velocity parameters.
Stopping room average, for example based on distance kept from vehicle(s) in front based on image processing of image data from a front camera that images the vehicles in front of the driven vehicle.
Lane compliance, for example based on image processing of image data from a front camera that images the cars in front of the driven vehicle.
Acceleration data, for example from an analysis of one or more accelerometers. For example, acceleration, braking and cornering data is combined with GPS location and compared with other drivers' data for the GPS location to deduce driving behavior.
Velocity data, for example from an analysis navigation module outputs. The velocity data may include adaptation of the velocity of the vehicle to the road parameters recorded at the time the velocity is measured. In another example speed limit compliance is determined based on a correlation between data from a navigation module, velocity data which may be extracted from the car subsystem during the ride, and permitted velocity data extracted from map data. In such embodiments, the driving behavior parameter is determined according to the level of adaptation of the driving velocity of the driver to the road parameters. For instance, velocity may be correlated with a curve level as extracted from navigation data or a gyroscope.
Sign compliance, for example based on image processing of images which image traffic lights, signs, and the like and the reaction of the vehicle to the signs. The images may be captured using a front camera that images the cars in front of the driven vehicle.
Noise level, for example based on audio processing of data gathered from a passenger compartment microphone located to record sounds at the passenger compartment, for example the microphone of a client terminal. The noise level may be averaged based on the driving period and/or correlated with road and/or velocity parameters.
Driver behavior reports, for example one or more recorded social reaction or reporting uploaded by another driver(s) or by law enforcement systems. For example, violation reports which are received for the respective vehicle from mobile communication devices of other drivers during the ride. These violation reports may be indicative of a traffic violation made by the vehicle and may indicate a category of the vehicle as a rogue vehicle.
Driver calmness, a parameter calculated based on one or more vehicle sensor readings such as speed, speed changing frequency, lane changing frequency, and/or the like. The Driver calmness calculation may take into account reading of a microphone or a camera that record sound and/or movement in the passenger compartment. These readings are optionally analyzed to determine calmness level of the driver, for example as known in the art.
Driving smoothness (quality of the smoothness of the ride), a parameter calculated based on one or more vehicle sensor readings such as speed, speed changing frequency, lane changing frequency, and/or the like.
Driving anticipation (quality of the avoidance of the driver from hazards), a parameter calculated based on one or more vehicle sensor readings such as braking intensity, speed changing frequency, lane changing frequency, and/or the like.

According to some embodiments of the present invention, the implications of a driving event on the insurance cost for the ride and/or for future ride is automatically presented to the user after the driving event is detected, for instance as an icon or a text message indicating of a penalty.

The central unit 201 has access to a plurality of insurance policies documented in a plurality of user profiles, also referred to as user records, which are stored in a local or remote database 206, 217. Each insurance policy optionally defines a current insurance rate for the user, for example periodical insurance rate and/or per-ride insurance rate; historical driving and accident data, for example claim history acquired from insurance company databases; history of one or more driving behavior parameters in previous rides; an insurance balance or remaining period calculated according to the current insurance rate, and/or the like. Optionally, the client modules 202 upload the sensor parameters and/or the driving behavior parameters and/or driving behavior parameters ride rating(s) and/or score(s) per-ride. In such embodiments, the user records may include data that reflects changes in the driving behavior of the respective user and/or use for statistical analysis. Optionally, historical data recorded in the user records allows scoring the accident tendency of a driver based on an average of previous ride rating(s) and/or scores or recorded performances in previous rides.

Optionally, the weight given to a recorded ride score is weighted relatively to the distance driven in that ride. Additionally or alternatively, the score is reduced or increased according to recorded offences or lack of recorded offences. The offences may be identified from an analysis of the claims, an analysis of the above driving behavior parameters as recoded in the user profile.

First, as shown at 101, an initiation of a ride with a vehicle driven a driver is identified, for example by the client module. For instance, the client module uses a GPS location change, a notification regarding ignition from a vehicle subsystem, and/or a user interface input from a user to determine the initiation of the ride.

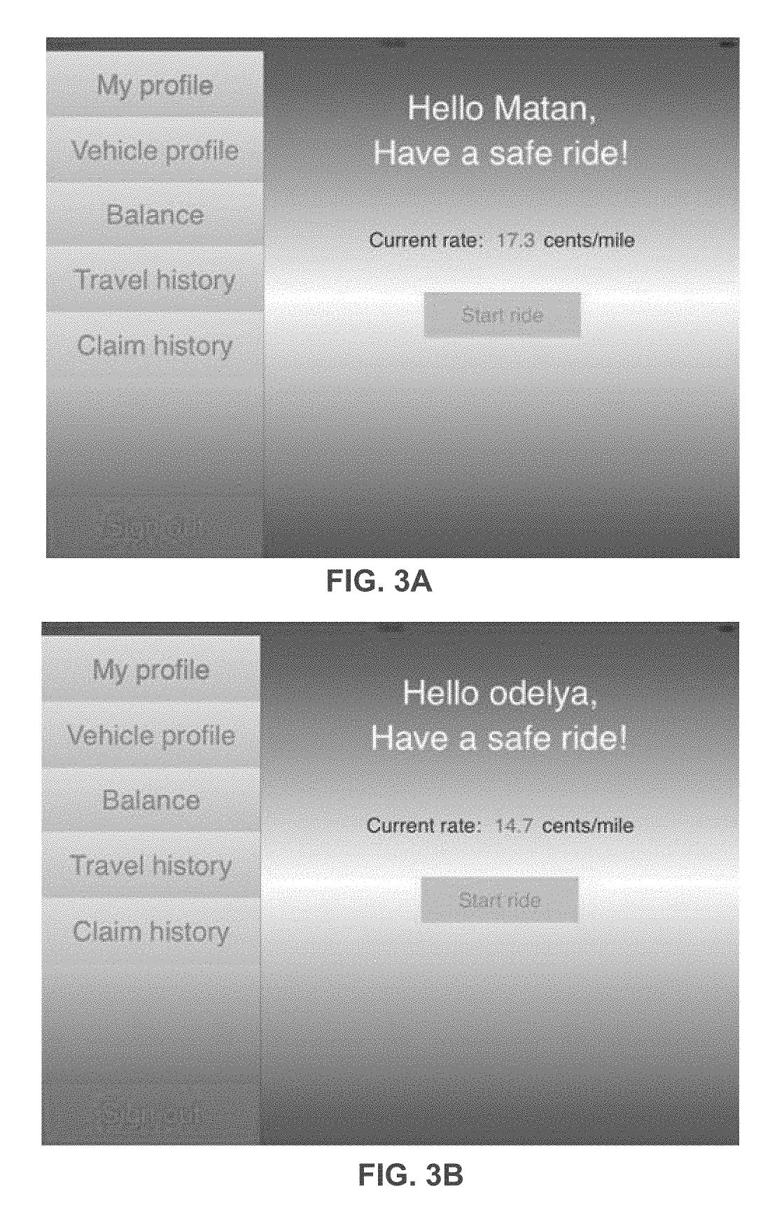

Optionally, a graphical user interface (GUI) that includes an initiation button and a personalized insurance rate, for instance a current rate per distance unit, for instance as depicted in FIGS. 3A and 3B, is presented on the display 207. The GUI allows the user to indicate a ride initiation, for instance by a press of a button.

Optionally initiation (and/or ride termination as described below) is detected based on an analysis of vehicle accessories. For example, the detection is based on an output of a Driver Assistance System, for example Mobileye™ and DISTRONIC PLUS™. In another example, the playing of music at the vehicle and/or the detection of driving sounds, for example by sound pattern analysis is used for determining ride initiation event(s) and/or ride termination event(s).

As described above, the client terminal may be a Smartphone or a wearable device. In such embodiments, the detection of ride initiation and/or ride termination events may be based on the detection of a pairing or a depairing of a wireless connection between a Driver Assistance System and the client terminal 203. The wireless connection may be a Bluetooth connection, a Wi-Fi connection, an NFC connection, and/or the like. Optionally, a wired connection may also be used for detecting ride initiation and/or ride termination events. In such embodiments, when a driver is proximate to the Driver Assistance System located in the vehicle, for example a speaker, and a connection is established with the client terminal 203 of the driver, a ride initiation event is detected. When a driver parks and the connection with the Driver Assistance System is depaired, for instance when the driver leaves the vehicle and the area therearound, a ride termination event is detected.

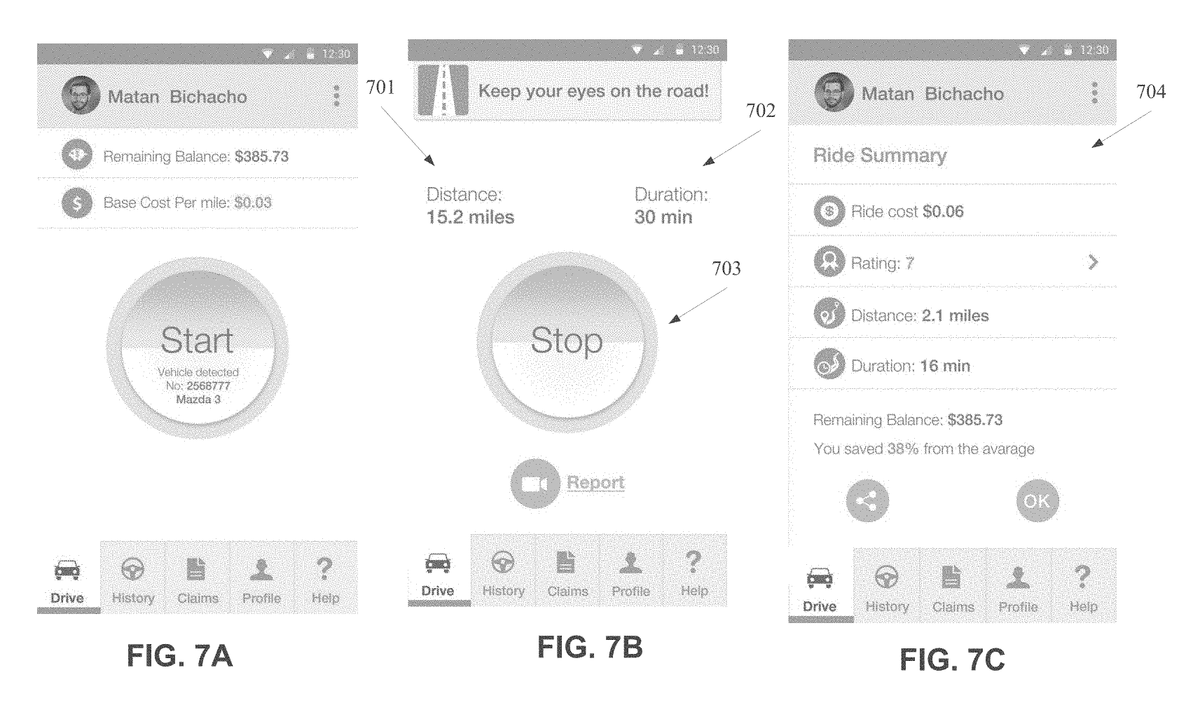

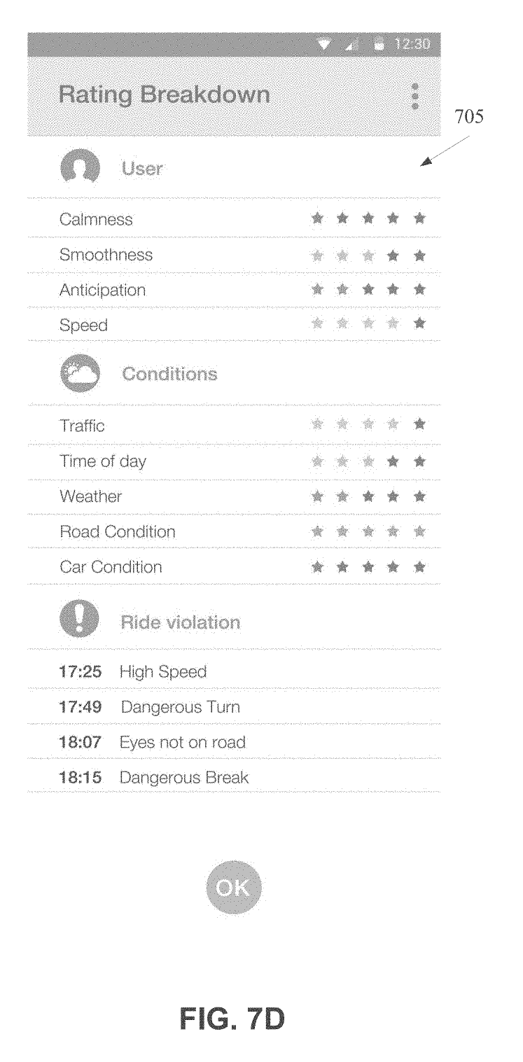

As shown at 102, a current insurance rate is received, at the client terminal from the central unit 203. The current insurance rate is optionally presented to the driver, for instance using the display 207, for instance as depicted in FIG. 7A. The current insurance rate may be a per distance rate, for instance as depicted in FIG. 7A, a per ride rate, a per period rate and/or the like. The current insurance rate is optionally received from the central unit 201, for example from a rate calculation module 204 which determines a rate based on the user profile of the drive. The calculation is supported by processor(s) 208 of the central unit 201. Optionally, the GUI allows the user to apply the insurance by a press of a button, for example by pressing start in FIG. 7A. Optionally, the GUI allows the user to determine manually whether to apply the insurance for the ride and/or to change. Optionally, the user can change the insurance setting and/or to select another insurance offer that may be presented to him.

As shown at 103, during the ride, driving parameter sensor parameters are gathered from driving parameter sensors. For instance, outputs of sensors such as vehicle sensors, image sensors and/or accelerometers are recorded by the client module 202.

Now, as shown at 104, ride termination event is detected, for example by the client module. For brevity, a ride termination event covers any ride insurance recalculation event. The ride insurance recalculation event may be an end of a period, a driven distance, a number of detected mal driving events, and/or a combination thereof. For instance, the client module uses a GPS location change, a notification regarding ignition from a vehicle subsystem, and/or a user interface input from a user to determine the termination of the ride and/or a ride insurance recalculation event. Termination may also be determined as described above.

As shown at 105, driving behavior parameters are calculated and scored based on the sensor parameters. This calculation and/or scoring may occur when ride termination and/or a ride insurance recalculation event is detected and/or continuously during the ride for calculating a ride score and/or ride rank. The calculation may be performed by a weighed function that takes into account a combination of the above described driving behavior parameters. The driving behavior parameters may be locally calculated on the client terminal 203 and/or sent for remote calculation by the central unit 201. The calculation may be performed by a rate calculation module which may be part of the client module 202 or hosted by the client central unit 204.

Now, as shown at 106, after the ride termination and/or the ride insurance recalculation event are detected, an insurance rate update to the insurance rate is calculated based on the driving behavior parameters and/or score.

As shown at 107, the insurance rate update is now displayed to the driver, optionally together with the current charges for the ride and/or the current insurance rate. This allows the driver to receive immediate feedback about his driving behavior in the form on a cost decrease or increase. For example, the insurance rate is a per-ride insurance rate and the presented update is for the per-ride insurance rate set for the next ride. In another example the change is an insurance rate change of an effect to an existing insurance rate. The presentation of the insurance rate update and/or the insurance rate change only when the ride is terminated allows avoiding unwanted distractions during the ride itself. For brevity, an insurance rate update and/or an insurance rate change may be referred to interchangeably.

Optionally, the update is sent to the central unit 201 via the network 205 for updating the respective user profile at the database 206, 217.

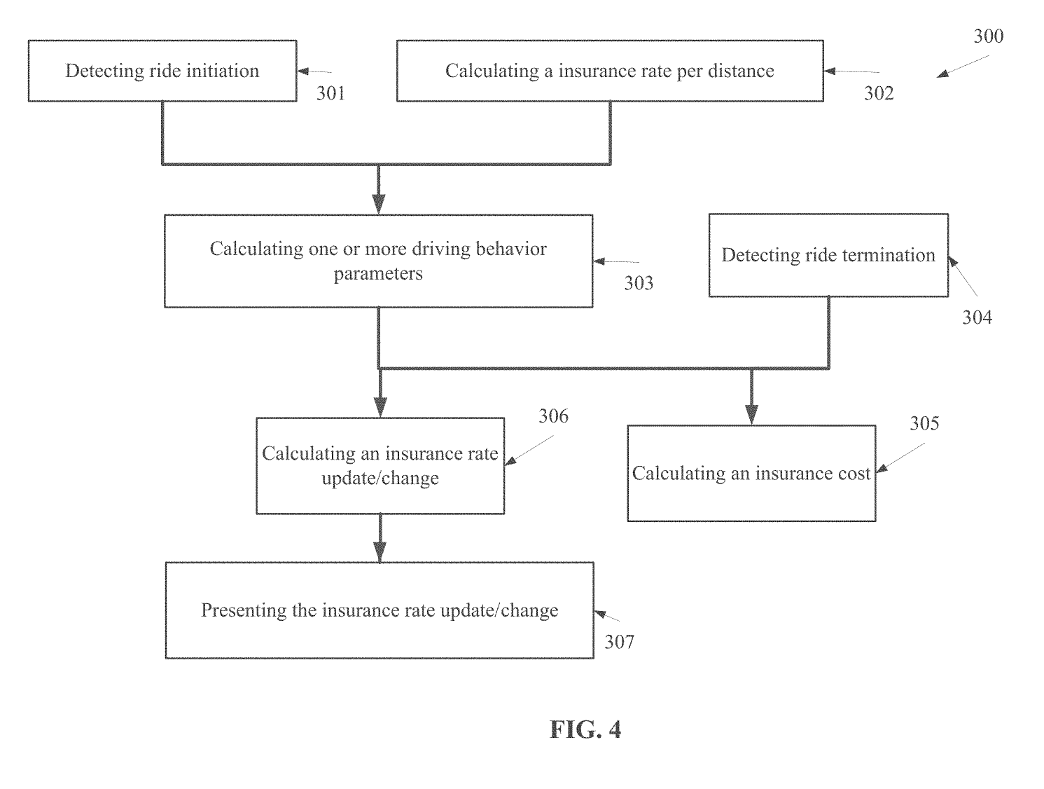

FIG. 4 depicts a flowchart of a method 300 personalizing a rate per distance unit insurance based on driving behavior parameters of a driver during a ride and presenting the insurance personalization outcome to the driver immediately when the ride is over, according to some embodiments of the present invention.

First, as shown at 301, a ride initiation is detected, for instance based on GPS location, vehicle subsystem data and/or user inputs as described above.

Now, as shown at 302, an insurance rate per distance unit is calculated based on a user and/or vehicle profile, for example based on a user and/or vehicle data extracted from the respective user record of the driver or the vehicle in the database 206. The distance unit may be one or more meter(s), kilometer(s), mile(s), feet(s) and/or the like. The insurance rate per distance unit may be calculated based on a current navigation data for a driving route set for a ride with the vehicle by the driver.

Optionally, environmental terms are also gathered, for example from a weather source and/or or from route analysis. The calculation may be done locally by the client module 202 or remotely at the central unit 201.

As shown at 303, driving behavior parameters reflecting driver behavior are calculated based on driving parameter sensor parameters gathered during the ride, for example as described above. As shown at 304, a termination of the ride is detected as described above.

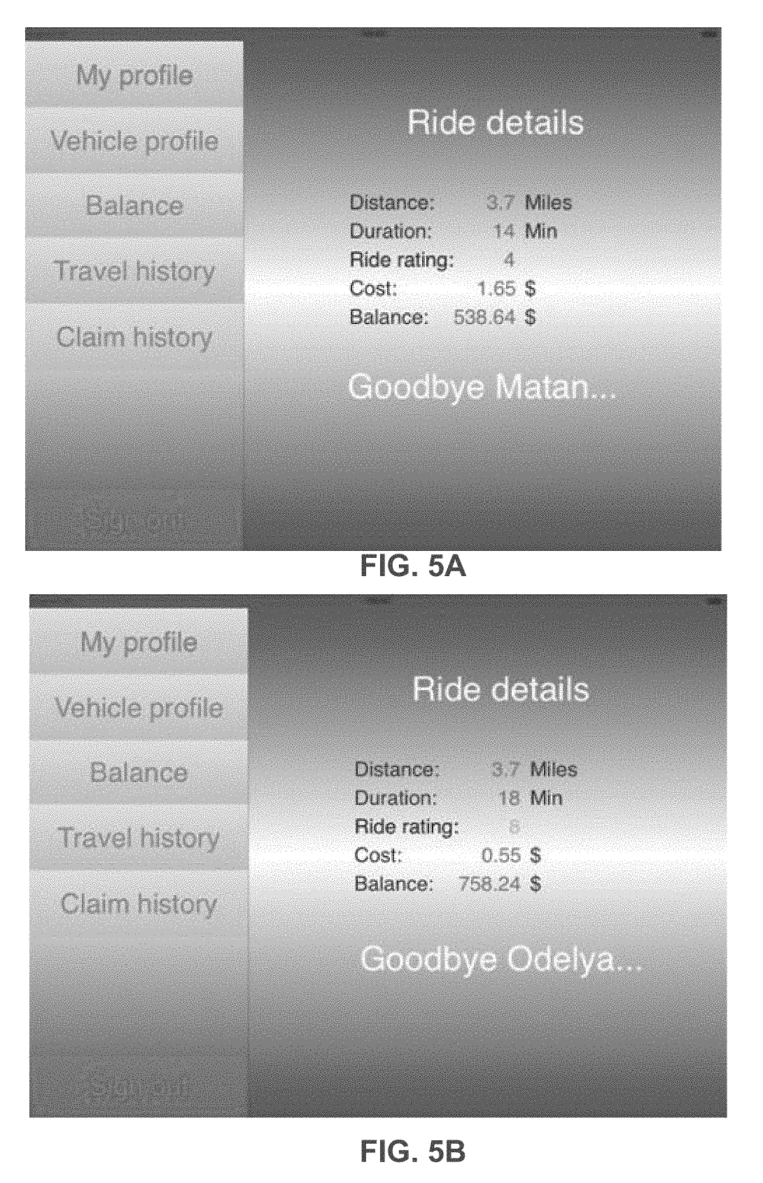

As shown at 305, an insurance cost for the ride is calculated according to a combination of a distance accumulated during the ride, for example based on navigation data, the insurance rate per distance unit. For example, as depicted in FIGS. 5A and 5B, are screenshots of exemplary presentations of the insurance cost for the ride, for example in addition with more related data, such as: distance travelled; ride duration; ride rating, optionally calculated based on the scores of the driving behavior parameters, for instance calculated as described above; an insurance balance and/or the like.

Optionally, the insurance cost is combined with additional parameter(s) to present a total cost per ride. For example, the insurance cost is combined with gasoline consuming data and value lost for the vehicle.

As shown at 306 an update to the insurance rate per distance unit is calculated based on the driving behavior parameter. For example, an update to the insurance rate per distance unit is calculated according to the driving behavior parameters which have recorded during the ride and optionally according to the road parameter and/or environmental terms. As shown at 307, the update to the insurance rate per distance unit is presented to the driver in the vehicle in response to the detection of the termination of the ride, for example by a wearable device, such as a head mounted display and/or a display of a Smartphone, a tablet, and an infotainment system installed in the vehicle.

Optionally, percentage of saving is also calculated and presented in response to the detection of the termination of the ride, for example in relation to driving cost of previous rides of the driver or in relation to an average of driving cost of other drivers in the driven route or in routes with similar characteristics. Optionally, only cost average of similar drivers, for instance drivers in a common demographic sector, is used.

Optionally, as shown at FIG. 7B, during the ride a user is presented with a ride data, for instance the user is presented with the distance 701 and the time 702 of a current insurance. Optionally, a GUI allowing a user to stop or pause the insurance, for instance 703, is presented to the user. Optionally, when the ride ends a ride summary, a report is presented to the user, for instance as depicted in FIG. 7C. This report presents ride insurance cost, ride distance, ride time, ride rating and/or the like. Optionally, the user can receive a ride rating breakdown, as shown at FIG. 7D. The ride rating breakdown details the score given to various driving behavior parameters such as calmness, smoothness, anticipation, and speed. The ride rating breakdown details objective parameters which are not related to the driver behavior however have effect on the cost, for instance traffic, time of day, weather, road conditions, car condition and/or the like. This data can be gathered from the vehicle sensors and from external sources such as a navigation software, a web available server etc.

Optionally, the current insurance rate per distance unit or the update to the insurance rate per distance unit may be calculated based on the processing of road condition parameters and/or environmental parameters which are gathered during the ride. For example, the road condition parameters may be based on an analysis of outputs of a sensor located in the car, such as accelerometer which records trembling of the vehicle in driven road may be analyzed to estimate of a road parameter such as a bumpiness level. In another example, the road condition parameters may be based on an analysis of outputs of an image sensor located in the car, such as a camera imaging the road in front of the vehicle in driven road may be imaged processed to estimate of a road parameter such as flatness level, traffic level, road quality level, daytime, and/or the like. The road condition parameters are related to road(s) driven during the ride and may be based on an analysis of map data. The road condition parameters may be based on statistical analysis of recorded driving data, for example detecting accident prevalence, offences prevalence, and/or the like. Environmental parameters related to the environment at the road(s) driven during the ride, such as time in day, Weather, average speed at location, and/or actual or estimated traffic may be extracted from navigation services, such as Google maps™ or Waze™, rich site summary (RSS) sources, and/or statistical analysis of recorded driving data.

According to some embodiments of the present invention, a route selection for navigation is calculated based on insurance rate per distance unit calculated as described above. In such embodiment, route may be weighted according to cost based on the insurance rate per distance unit, optionally in combination with fuel consumption and vehicle value degradation data.

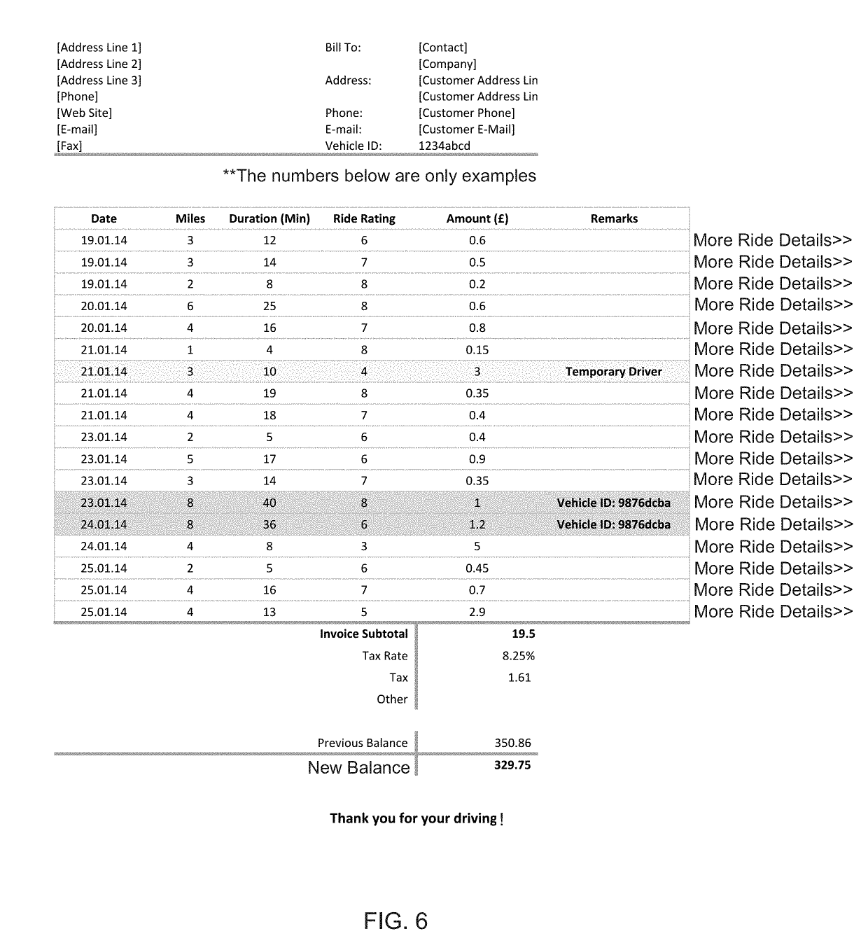

According to some embodiments of the present invention, the system 200 is used for generating reports for the users, allowing them to learn about changes in their insurance spending during a period of a week, a month, a yearly quarter, or a year. As described above, the user profile documents historical data regarding rides and rates. This allows generating detailed reports, for example with graphical or textual indications of trends and sending them or presenting them to the user. The report may be a basis for a periodic invoice which is generated to the client. For instance FIG. 6 is a screenshot of an exemplary report (invoice) that details insurance cost per ride, according to some embodiments of the present invention. The report includes a table wherein each row details the date, the distance, the duration, the ride rate or score the user received based driving behavior parameters gathered during the ride, and the cost of a certain ride. The report includes a remark section for indicating exceptions.

The methods as described above are used in the fabrication of integrated circuit chips.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant methods and systems will be developed and the scope of the term a unit, a network, and a module is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A method for personalizing a per ride insurance rate, comprising:
using at least one hardware processor of a client terminal located in a vehicle driven by a driver for executing a code for:
receiving a current insurance rate per distance unit calculated based on a user profile of at least one of said driver and said vehicle;
presenting said current insurance rate per distance unit on a display of said client terminal;
identifying an initiation of said ride with said vehicle by said driver;
calculating a plurality of driving behavior parameters reflecting driver behavior during said ride according to outputs of at least one driving parameter sensor mounted in said vehicle during said ride;
identifying a termination of said ride;
in response to the detection of said termination;
calculating an insurance cost for said ride according to a distance accumulated during said ride and said current insurance rate per distance unit;
calculating an update to said current insurance rate per distance unit according to said plurality of driving behavior parameters; and
presenting said update and said insurance cost on said display of said client terminal to said driver in said vehicle.

2. The method of claim 1, further comprising:
detecting a driving event indicative of a driving behavior pattern during said ride according to outputs of said at least one driving parameter sensor, and
in response to said detecting, presenting to said driver an estimated effect of said driving event on said insurance cost during said ride.

3. The method of claim 1, wherein said plurality of driving behavior parameters comprises a speed compliance calculated based on an analysis of velocity data gathered during said ride.

4. The method of claim 1, wherein said at least one driving parameter sensor comprises a plurality of driving parameter sensors; wherein said plurality of driving behavior parameters comprises a adaptation of the driving to road conditions calculated based on an analysis of a correlation between outputs of said plurality of driving parameter sensors.

5. The method of claim 1, wherein said plurality of driving behavior parameters comprises a reaction time calculated based on an analysis of image data gathered during said ride from said at least one driving parameter sensor.

6. The method of claim 1, wherein said at least one driving parameter sensor comprises a passenger compartment camera which images at least part of the passenger compartment space; wherein said plurality of driving behavior parameters comprises at least one of a mirrors check frequency, shifting a road gaze frequency, and a blind spot check frequency calculated based on an analysis of image data during said ride from said passenger compartment camera.

7. The method of claim 1, wherein said plurality of driving behavior parameters comprises at least one recorded driving behavior report documenting a vehicle driving violation during said ride, said at least one recorded driving behavior report being uploaded by at least one of a another driver and a law enforcement system.

8. The method of claim 1, wherein said at least one driving parameter sensor comprises a front camera which images the space in front and/or back of said vehicle; wherein said at least one driving parameter sensor comprises a stopping room average calculated based on an analysis of image data during said ride from said front camera.

9. The method of claim 1, wherein said at least one driving parameter sensor comprises a front camera which images the space in front of said vehicle; wherein said at least one driving parameter sensor comprises at least one of a lane compliance and a sign compliance calculated based on an analysis of image data during said ride from said front camera.

10. The method of claim 1, wherein said at least one driving parameter sensor is selected from a group consisting of an accelerometer, an image sensor, a magnetometer, a navigation system, an external insurance policy enforcement device, and a safety belt compliance sensor.

11. The method of claim 1, wherein said client terminal is a Smartphone set to be mounted in said vehicle during said ride.

12. The method of claim 1, wherein said client terminal is a subsystem of said vehicle.

13. The method of claim 1, wherein said current insurance rate per distance unit is received over a network from a central unit; further comprising sending said update to said central unit for updating said current insurance rate per distance unit.

14. The method of claim 1, wherein identifying said initiation and identifying said termination is performed by detecting a presence or an absence of wireless signal from an accessory of said client terminal.

15. The method of claim 1, wherein identifying said initiation and identifying said termination is performed by detecting a pairing between an accessory of said client terminal and said client terminal.

16. The method of claim 1, further comprising calculating a ride cost for said ride based on a combination of said insurance cost and at least one of gasoline consuming data and value lost for the vehicle estimation; wherein said presenting comprises presenting said ride cost.

17. The method of claim 1, wherein said calculating an update is performed based on road condition parameters which are associated with the condition of at least one road driven during said ride.

18. The method of claim 1, wherein said calculating an update is performed based on environmental parameters reflecting environment condition during said ride at least one road driven during said ride.

19. A computer readable medium comprising computer executable instructions adapted to perform the method of claim 1.

20. The method of claim 1, further comprising generating a report which details said insurance with a plurality of characterizing features of said ride as a row in a table.

21. A method for presenting insurance data, comprising:
using at least one hardware processor of a client terminal located in a vehicle driven by a driver for executing a code for:
presenting on a display of said client terminal an insurance rate set for at least one of said driver and said vehicle based on a plurality of driving behavior parameters;
identifying an initiation of a ride with a vehicle driven by a driver;
gathering a plurality of driving parameter sensor parameters from at least one driving parameter sensor mounted in said vehicle during said ride;
calculating a plurality of current driving behavior parameters reflecting a driver behavior during said ride according to an analysis of said plurality of driving parameter sensor parameters;
identifying a termination of said ride;
automatically calculating an update to said insurance rate based on said plurality of current driving behavior parameters; and
presenting said update to said driver in said display in said vehicle in response to the detection of said termination.

22. A system for personalizing a per ride insurance rate, comprising:
a database which hosts a plurality of user records, each one of said plurality of user records documents a current insurance rate per distance unit calculated for at least one of a driver and a vehicle;
hardware processor for executing a code for:
identifying an initiation and a termination of a ride with said vehicle by said driver and for gathering outputs of at least one driving parameter sensor mounted in said vehicle during said ride, and
a plurality of driving behavior parameters reflecting driver behavior during said ride according to said outputs and configured to calculate an insurance cost for said ride according to a distance accumulated during said ride and said current insurance rate per distance unit;
wherein said hardware processor is configured to calculate an update to said current insurance rate per distance unit according to said plurality of driving behavior parameters; and
wherein said hardware processor is configured to instruct a display of said client terminal to present;
said current insurance rate per distance unit to said driver before said initiation and to present said update, and
said current insurance rate per distance unit and said insurance cost to said driver in said vehicle in response to the detection of said termination.
